(19) United States
(12) Patent Application Publication
(10) Pub. No.: US 2014/0075750 A1
(43) Pub. Date: Mar. 20, 2014

(54) TOUCH SCREEN PANEL AND METHOD OF PREPARING THE SAME

(71) Applicant: DONGWOO FINE-CHEM CO., LTD., Jeollabuk-do (KR)

(72) Inventors: Yong-Seok CHOI, Jeollabuk-do (KR); Won-Young CHANG, Daejeon (KR); Ji-Min CHUN, Jeollabuk-do (KR); Young-Jun JIN, Jeollabuk-do (KR)

(73) Assignee: DONGWOO FINE-CHEM CO., LTD., Jeollabuk-do (KR)

(21) Appl. No.: 13/971,857

(22) Filed: Aug. 21, 2013

(30) Foreign Application Priority Data
Sep. 20, 2012 (KR) 10-2012-0104554
Sep. 21, 2012 (KR) 10-2012-0104979
Aug. 8, 2013 (KR) 10-2013-0094018

(51) Int. Cl. G06F 3/041

(52) U.S. Cl. CPC G06F 3/041
USPC 29/831; 430/321; 427/58; 428/201

(57) ABSTRACT

A touch screen panel and a method for preparing the same, and more specifically, a touch screen panel includes a window plate 311, a non-conductive color pattern 312 formed on a non-display part on one face of the window plate, and a non-conductive shielding pattern 313 formed on the non-conductive color pattern 312, so as to provide a non-conductive pattern having the desired colors and shielding effects, and to reduce failure rates during the formation of the non-conductive pattern, as well as a method for preparing the same.

### CROSS REFERENCE TO RELATED APPLICATIONS AND CLAIM OF PRIORITY

This application claims priority to Korean Patent Application No. 10-2012-0104554, filed on Sep. 20, 2012, Korean Patent Application No. 10-2012-0104979, filed on Sep. 21, 2012, and Korean Patent Application No. 10-2013-0094018, filed on Aug. 8, 2013 in the Korean Intellectual Property Office, the entire disclosure of which is incorporated herein by reference.

### BACKGROUND

1. Field of the Invention

The present invention relates to a touch screen panel and a method for preparing the same.

2. Description of the Related Art

A touch screen is a screen equipped with a special input device to receive positional input by touching the screen with a finger or a stylus pen.

The touch screen does not use a keyboard, but when the finger of a human or an object such as a stylus pen touches a specific character or position displayed on a screen, the touch identifies the touched position and directly transmits data through a screen picture, in order to process the data by appropriate software stored therein.

Conventional touch screens have been manufactured by preparing an ITO film and a window, in respective independent processes, followed by combining the ITO film and window. However, in recent years, the window has usually been integrated with the ITO film through a series of processes.

A typical touch screen panel includes a display part of a transparent image sensor displaying images on a front face thereof, and a non-display part surrounding the display part of the image sensor, as shown in FIG. 1, wherein the display part of the image sensor is an area receiving touch input by the finger of a user, while the non-display part has a trademark or logotype of a mobile phone manufacturer printed thereon or hides an opaque conductive wiring pattern therein.

Recently, portable mobile devices are widely used and garner great interest in terms of design(s), or the like. In particular, a display part of the mobile device, such as a mobile phone, increasingly demands a variety of colors such as white, pink, yellow, etc., other than a typical color(s), viz., black.

Although various methods have been introduced to satisfy the demand described above, there is the problem of requiring the preparation of alternative ink(s) or materials that can achieve the desired colors and have a concomitant “hiding” function, as an ultimate aim.

Meanwhile, a non-conductive pattern is conventionally formed by screen printing, wherein the screen printing includes placing an ink composition for forming a non-conductive pattern on a patterned screen, and then directly providing the ink composition for forming a non-conductive pattern on a window plate through a screen having an empty inner-space using a squeegee.

When forming the non-conductive pattern by screen printing as described above, the printing process must be executed two to eight times in order to acquire shielding effects through the non-conductive pattern. As a result, the pattern becomes thickened, which in turn increases the overall thickness of the touch screen panel. Due to a step height caused by the above conditions, there is inherent difficulty in forming a conductive electrode pattern layer.

Further, the non-conductive pattern is formed on the completely processed window plate. In this regard, the processed window plate has holes for arranging a speaker, and buttons therein, which exacerbates the problem of leakage of the ink through the holes of the window plate during screen printing.

Korean Patent Laid-Open Application No. 2007-95425 discloses a photo-curable resin composition for forming a black matrix, a photoresistant film using the same, a method for forming a black matrix, the black matrix, and a plasma display panel having the same, however, the application has proposed no alternative idea(s) or solution(s) to overcome the above problem.

### SUMMARY

Accordingly, an aspect of the present invention is to provide a method for preparing a touch screen panel provided with a non-conductive pattern having the desired colors and shielding effects.

Another aspect of the present invention is to provide a method for preparing a touch screen panel with reduced failure rates during the formation of a non-conductive pattern.

According to an aspect of the present invention, a non-conductive color pattern and a non-conductive shielding pattern are provided, so as to form a non-conductive pattern having the desired colors and a shielding function thereon.

An according to an aspect of the present invention, a touch screen panel includes a window plate, a non-conductive color pattern formed on a non-display part on one face of the window plate, and a non-conductive shielding pattern formed on the non-conductive color pattern.

The window plate may be formed of at least one selected from the group consisting of glass, polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), cellulose acetate propionate (CAP), and a combination thereof.

An overall thickness of the non-conductive color pattern and non-conductive shielding pattern may range from 1 to 10 μm.

A thickness ratio between the non-conductive color pattern and the non-conductive shielding pattern may range from 1:0.1 to 0.5.

A light transmittance of the non-conductive shielding pattern may range from 0.1 to 5% of light-transmittance of the non-conductive color pattern.

The non-conductive color pattern and non-conductive shielding pattern may be formed by offset printing or photolithography, independently of each other.

According to an aspect of the present invention, a method for preparing a touch screen panel, includes forming a non-conductive color pattern on a non-display part on one face of a window plate by offset printing or photolithography, and forming a non-conductive shielding pattern on the non-conductive color pattern by offset printing or photolithography.

The non-conductive color pattern formed by offset printing may be provided using a composition for forming a non-conductive color pattern, which includes a coloring agent, binder resin, polymerizable compound, polymerization initiator, and solvent.

The non-conductive color pattern formed by photolithography may be provided using a compositing for forming a non-conductive color pattern, which includes a coloring agent, alkaline soluble resin, polymerizable compound, polymerization initiator, and solvent.

The non-conductive shielding pattern formed by offset printing may be provided using a composition for forming a non-conductive shielding pattern, which includes a shielding agent, binder resin, polymerizable compound, polymerization initiator, and solvent.

The non-conductive shielding pattern formed by photolithography may be provided using a composition for forming a non-conductive shielding pattern, which includes a shielding agent, alkaline soluble resin, polymerizable compound, polymerization initiator, and solvent.

The composition for forming a non-conductive color pattern and the composition for forming a non-conductive shielding pattern may have a viscosity of 1 to 30 cps, respectively.

The method may further include forming a conductive electrode pattern layer on the window plate having the non-conductive pattern formed thereon, forming an electrode pattern on an area corresponding to the non-display part in the conductive electrode pattern layer, forming a scattering-preventative film on the window plate having the conductive (transparent) electrode pattern layer and the electrode pattern formed thereon, and connecting the electrode pattern to a terminal of a printed circuit board.

The conductive electrode pattern layer and the electrode pattern may be independently formed of at least one selected from the group consisting of indium-tin oxide (ITO), indium-zinc oxide (IZO), zinc oxide (ZnO), indium-zinc-tin oxide (IZTO), cadmium-tin oxide (CTO), poly(3,4-ethylenedioxythiophene)(PEDOT), carbon nanotube (CNT), and metal wire.

The present invention may reduce failure rates in forming a non-conductive pattern.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a perspective view illustrating one example of an application for a conventional touch screen panel;

FIG. 2 is a vertical cross-sectional view of a touch screen panel according one embodiment of the present invention;

FIG. 3 illustrates a process of forming a non-conductive pattern by offset printing according to the present invention;

FIG. 4 schematically illustrates one embodiment of offset printing in the formation of a non-conductive pattern;

FIG. 5 illustrates a process of forming a non-conductive pattern through photolithography according to the present invention;

FIG. 6 illustrates a method for preparing a touch screen panel including a process of forming a non-conductive pattern by offset printing according to the present invention; and

FIG. 7 illustrates a method for preparing a touch screen panel including the formation of a non-conductive pattern through photolithography according to the present invention.

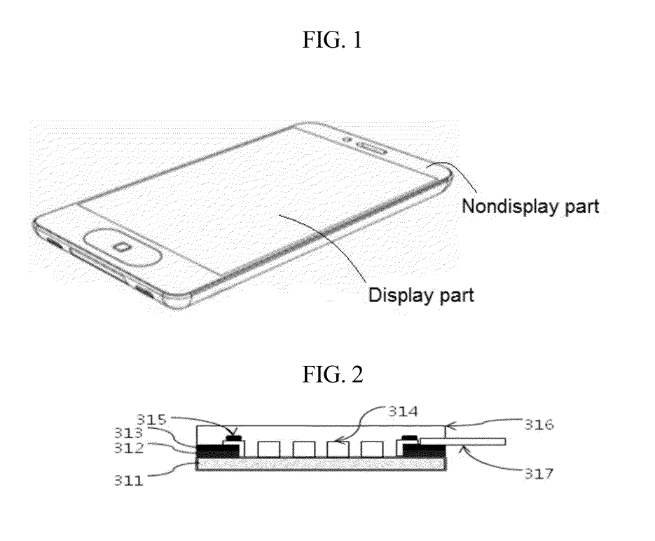

### DETAILED DESCRIPTION OF EMBODIMENTS

The present invention discloses a touch screen panel, which includes: a window plate 311; a non-conductive color pattern 312 formed on a non-display part on one face of the window plate; and a non-conductive shielding pattern 313 formed on the non-conductive color pattern 312, so as to form a non-conductive pattern having the desired colors and shielding effects thereon, and reduce failure rates during the formation of the non-conductive pattern, as well as a method for preparing the same.

Hereinafter, the present invention will be described in detail with reference to the drawings.

<Touch Screen Panel>

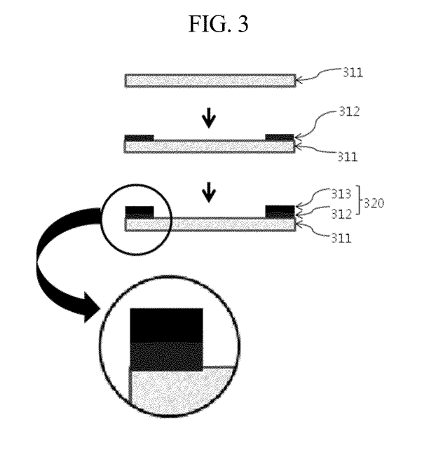

FIG. 2 is a vertical cross-sectional view schematically illustrating a touch screen panel according to one embodiment of the present invention.

The touch screen panel of the present invention includes a window plate 311, a non-conductive color pattern 312 formed on a non-display part on one face of the window plate 311, and a non-conductive shielding pattern 313 formed on the non-conductive color pattern 312.

Since the touch screen panel of the present invention has the non-conducive color pattern 312 and the non-conductive shielding pattern 313, separately, a non-conductive pattern with shielding and hiding effects as well as various colors may be provided.

Further, since the non-conductive pattern according to the present invention has a relatively decreased thickness, a thinner display may be produced, ink leakage through the holes of the window plate may be prevented, and the reliability of a conductive electrode pattern layer may be improved, thereby reducing failure rates.

A window plate 311 is in-part receiving contact input from a specific object, such as the fingers of a user or a stylus pen, etc., and has a role in securing the outer appearance of a touch screen panel.

The window plate 311 may be prepared of any material, without limitation, so long as it has the durability to sufficiently protect the touch screen panel from external forces and allow users to optimally view the display, and may include, for example, glass, polyethersulfone (PES), polyacrylate (PAR), polyetherimide (PEI), polyethylene napthalate (PEN), polyethylene terepthalate (PET), polyphenylene sulfide (PPS), polyallylate, polyimide, polycarbonate (PC), cellulose triacetate (TAC), cellulose acetate propionate (CAP), or the like, which can be used alone or in combination with two or more thereof.

The non-conductive color pattern 312 may provide various colors to a non-conductive pattern of the non-display part.

The non-conductive shielding pattern 313 is formed on the non-conductive color pattern 312 and may play a role in the hiding and shielding an inner board and the wiring of a device.

An overall thickness of the non-conductive color pattern and non-conductive shielding pattern may range from 1 to 10 μm and, preferably, 1 to 5 μm. When an overall thickness of the non-conductive pattern is within the above range, the hiding and shielding effects are reliably attained in hiding an inner board and wiring of a device, the reliability of a conductive electrode pattern layer is improved, and a thin touch screen panel may be produced.

A thickness ratio between the non-conductive color pattern and the non-conductive shielding pattern may range from 1:0.1 to 0.5, preferably, 1:0.1 to 0.3. When the thickness ratio between the non-conductive color pattern 312 and the non-conductive shielding pattern 313 is within 1:0.1 to 0.5, the inner board and the wiring of the device may be hidden and shielded, while expressing various colors.

The light transmittance of the non-conductive shielding pattern 313 may be 0.1 to 5%, preferably, 0.1 to 3% of light transmittance of the non-conductive color pattern 312. When the light transmittance of the non-conductive shielding pattern 313 is within the above range, shielding effects to hide the inner board and wiring may be maximized.

A method for forming the non-conductive color pattern 312 and non-conductive shielding pattern 313 is without limitation and may include any method conventionally used in the related art. In particular, in view of decreasing the thickness to achieve a thinner display, preventing ink leakage through the holes of a window plate, and improving the reliability of a conductive electrode pattern layer to reduce failure rates, offset printing or photolithography may be used independently of each other.

The touch screen panel of the present invention may further include any configuration conventionally used in the related art other than the non-conductive pattern described above, for example: a conductive electrode pattern layer 314 formed on the window plate 311 having the non-conductive pattern 320 formed thereon; an electrode pattern 315 formed on an area corresponding to the non-display part in the conductive electrode pattern layer 314; a scattering-preventative film 316 formed on the window plate 311 having the conductive (transparent) electrode pattern layer 314 and electrode pattern 315 formed thereon; and a terminal 317 of a printed circuit board connected to the electrode pattern 315.

The conductive electrode pattern layer 314 may play a role in detecting static electricity generated from the body of a human when his or her finger contacts a display part as a touch area of an image sensor, thereby converting it into electric signals.

A conductive material used for forming the conductive electrode pattern layer 314 is without limitation and may include, for example, indium-tin oxide (ITO), indium-zinc oxide (IZO), zinc oxide (ZnO), indium-zinc-tin oxide (IZTO), cadmium-tin oxide (CTO), poly(3,4-ethylenedioxythiopene) (PEDOT), carbon nanotube (CNT), metal wire, etc., which can be used alone or in combination with two or more thereof.

Metals used in the metal wire are without limitation and may include, for example, silver, gold, aluminum, copper, iron, nickel, titanium, tellurium, chromium, etc., which can be used alone or in combination with two or more thereof.

The electrode pattern 315 plays a role of delivering the electrical signal generated from the conductive electrode pattern layer 314 to a flexible printed circuit board (FPCB), IC chips, or the like, by touching the display part of the window plate 311.

The scattering-preventative film 316 may play a role in protecting both the patterns 314 and 315, and preventing the same from being scattered when the window is broken.

Materials of the scattering-preventive film 316 are without limitation so long as the materials are transparent and provide durability, and may include, for example, polyethylene terephthalate (PET).

For the printed circuit board, various types of printed circuit boards may be used, for example, a flexible printed circuit board (FPCB) may be used.

<Preparation of Touch Screen Panel>

The present invention also provides a method for preparing a touch screen panel.

Conventionally, a non-conductive pattern in a non-display part of a window plate in a touch screen panel has been formed as a single layer. In this case, in order to achieve shielding effects while having a desired color within such a single layer, the thickness of the layer is inevitably increased, or a variety of desired colors cannot be provided, since a proper thickness should be maintained. Furthermore, there are problems with the development of alternative ink(s) having the desired shielding effects and colors.

Non-conductive patterns are mostly formed using screen printing. In this regard, in order to attain shielding effects through the non-conductive pattern, the printing must be repeatedly executed to increase the thickness of the pattern. Accordingly, due to a step height caused by the increased thickness, there are problems such as difficulties in forming a conductive electrode pattern layer, increases in overall thickness of a touch screen panel, and ink leakage through the holes of a window plate.

Alternatively, the touch screen panel of the present invention has a non-conductive color pattern and a non-conductive shielding pattern, separately, to include a non-conductive pattern that has shielding and hiding effects, as well as various colors.

Also, the present invention may produce a thin touch screen panel by decreasing the thickness of the non-conductive pattern, thereby preventing ink leakage through the holes of a window plate, and improving the reliability of a conductive electrode pattern layer, which in turn reduces failure rates.

The method for preparing a touch screen panel according to the present invention may include forming a non-conductive color pattern 312 and a non-conductive shielding pattern 313, respectively, by offset printing or photolithography, independently of each other. For instance, the non-conductive color pattern 312 may be formed by offset printing while the non-conductive shielding pattern 313 may be formed by photolithography, or vice versa. Alternatively, both of the above patterns may be formed by offset printing, or alternatively, both patterns may be formed by photolithography.

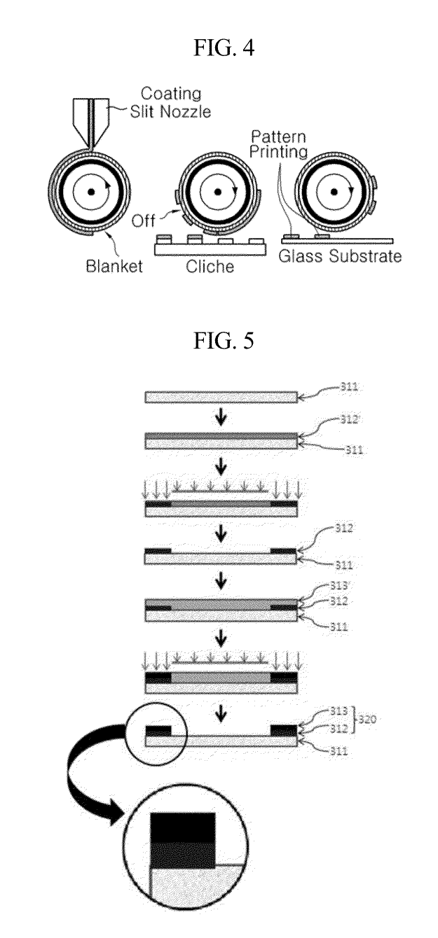

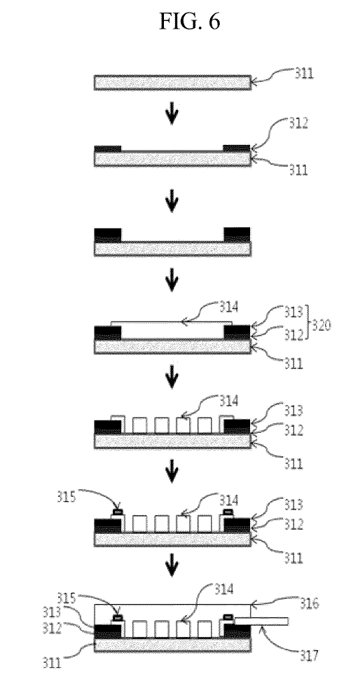

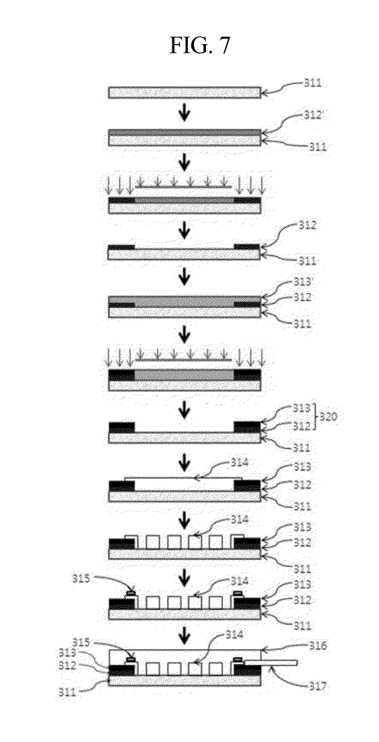

FIG. 3 illustrates a process of forming a non-conductive pattern by offset printing; FIG. 4 illustrates one embodiment of the offset printing during the formation of a non-conductive pattern; FIG. 5 illustrates a process of forming a non-conductive pattern by photolithography; FIG. 6 illustrates a process of preparing a touch screen panel that includes forming a non-conductive pattern by offset printing; and FIG. 7 illustrates a process of preparing a touch screen panel that includes forming a non-conductive pattern by photolithography.

Hereinafter, a method for preparing a touch screen panel according to one embodiment of the present invention will be described step-by-step, in detail, with reference to the drawings.

<Formation of a Non-Conductive Color Pattern by Offset Printing>

Offset printing is a process of transferring ink images on a rubber blanket on a printing side and printing the same on a subject to be printed, and the types of offset printing are without limitation and may include, for example, gravure offset printing, reverse offset printing, etc. Preferably, reverse offset printing is used. FIG. 4 schematically illustrates one embodiment of the reverse offset printing mode. More particularly, this method may be executed by applying an ink composition for forming a non-conductive pattern to a blanket, contacting the blanket with an embossed cliché to form a desired pattern, and transferring the formed pattern to one face of a window plate.

A conventional non-conductive pattern was generally formed by screen printing, wherein an ink composition for forming a non-conductive pattern is placed on a patterned screen and the ink composition for forming a non-conductive pattern is directly provided on a window plate through a screen having an empty inner-space using a squeegee.

For screen printing, since a pigment typically includes large particles and has a rough surface, printing must be repeatedly conducted two to eight times in order to attain the desired shielding effects through the non-conductive pattern. Accordingly, in repeatedly printing four times, the thickness of the non-conductive pattern increases to about 20 μm, hence causing problems with increasing the overall thickness of the touch screen panel.

Furthermore, the conductive electrode pattern layer typically included in the touch screen panel is formed to cover the non-conductive pattern and window plate. However, since the non-conductive pattern is thickened, the reliability of the conductive electrode pattern layer at a lateral side of the non-conductive pattern is diminished.

However, in the case of offset printing, a pigment having a small particle size is generally used, and a process of coating a blanket with the pigment and transferring the pigment on the same is employed, so that the panel has uniform surface flatness and the smaller pigment particles ensure uniform packing effects, thus achieving the desired shielding effects by the non-conductive pattern even if printing is executed only once.

Accordingly, a thin touch screen panel may be produced, and the surface roughness thereof is uniform and improves the reliability of a conductive electrode pattern formed on the non-conductive pattern. Further, according to the design of the embossed cliché, the transferring is executed in one-to-one, thus not causing problems with ink leakage through the holes of a window plate.

The non-conductive color pattern 312 formed by offset printing may be provided using a composition for forming a non-conductive color pattern, which includes a coloring agent, binder resin, polymerizable compound, polymerization initiator, and solvent.

Coloring agents are without limitation so long as they can embody a color required by a user and may include, for example: red, green, or blue dyes or pigments; yellow, orange, violet, or brown dyes or pigments for the combination of colors; black pigments; carbon black, and the like, which can be used alone or in combination with two or more thereof.

The coloring agent may further include metal powder, white pigments, fluorescent pigments, etc., where necessary.

The pigment may be an inorganic pigment or organic pigment.

Inorganic pigments are without limitation and may include, for example, barium sulfate, lead sulfate, titanium oxide, yellow lead, Bengal lead, calcium carbonate, chromium oxide, carbon black, or the like.

Organic pigments are without limitation and may include pigments listed by Color Index (C.I.) numbers.

Yellow pigments may include, for example, C.I. pigment yellow 1, 2, 3, 4, 5, 6, 12, 13, 14, 16, 17, 24, 55, 65, 73, 74, 81, 83, 87, 93, 94, 95, 97, 100, 101, 105, 108, 109, 110, 116, 120, 127, 128, 129, 133, 138, 139, 147, 148, 150, 151, 153, 154, 155, 166, 168, 169, 170, 172, 173, 174, 175, 176, 180, 185, 193, 194, 202, or the like.

Orange pigments may include, for example, C.I. pigment orange 1, 2, 5, 13, 16, 17, 19, 22, 24, 34, 36, 38, 39, 43, 46, 48, 61, 62, 64, 65, 67, 69, 73, 77, or the like.

Red pigments may include, for example, C.I. pigment red 1, 2, 3, 4, 5, 6, 8, 9, 12, 14, 15, 17, 22, 23, 31, 37, 38, 41, 48:1, 48:2, 48:3, 49, 50:1, 52:1, 53, 57:1, 58:4, 60, 63, 64, 68, 81, 88, 90:1, 112, 114, 122, 123, 144, 146, 147, 149, 150, 151, 166, 168, 170, 175, 176, 177, 178, 179, 181, 185, 187, 188, 190, 193, 194, 202, 207, 208, 209, 214, 216, 220, 221, 224, 242, 243, 245, 247, 254, 255, 264, 272, or the like.

Violet pigments may include, for example, C.I. pigment violet 1, 2, 3, 5, 19, 23, 29, 31, 32, 37, 39, 50, or the like.

Blue pigments may include, for example, C.I. pigment blue 1, 15:1, 15:2, 15:3, 15:4, 15:6, 16, 17, 25, 56, 60, 66, 75, 79, or the like.

Green pigments may include, for example, C.I. pigment green 2, 7, 8, 13, 36, 54, or the like.

Brown pigments may include, for example, C.I. pigment brown 1, 22, 23, 25, 27, or the like.

Black pigments may include, for example, C.I. pigment black 1, 7, 31, 32, or the like.

Dyes are without limitation and may include, for example, azo dyes, anthraquinone dyes, phthalocyanine dyes, quinonimine dyes, quinoline dyes, nitro dyes, carbonyl dyes, methyne dyes, or the like.

Azo dyes are without limitation and may include, for example, C.I. acid yellow 11, C.I. acid orange 7, C.I. acid red 37, C.I. acid red 180, C.I. acid blue 29, C.I. direct red 28, C.I. direct red 83, C.I. direct yellow 12, C.I. direct orange 26, C.I. direct green 28, C.I. direct green 59, C.I. reactive yellow 2, C.I. reactive red 17, C.I. reactive red 120, C.I. reactive black 5, C.I. disperse orange 5, C.I. disperse red 58, C.I. disperse blue 165, C.I. basic blue 41, C.I. basic red 18, C.I. mordant red 7, C.I. mordant yellow 5, C.I. mordant black 7, or the like.

Anthraquinone dyes are without limitation and may include, for example, C.I. bat blue 4, C.I. acid blue 40, C.I. acid green 25, C.I. creative blue 19, C.I. creative blue 49, C.I. disperse red 60, C.I. disperse blue 56, C.I. disperse blue 60, or the like.

Phthalocyanine dyes are without limitation and may include, for example, C.I. pad blue 5 or the like.

Quinonimine dyes are without limitation and may include, for example, C.I. basic blue 3, C.I. basic blue 9, or the like.

Quinoline dyes are without limitation and may include, for example, C.I. solvent yellow 33, C.I. acid yellow 3, C.I. disperse yellow 64, or the like.

Nitro dyes are without limitation and may include, for example, C.I. acid yellow 1, C.I. acid orange 3, C.I. disperse yellow 42, or the like.

Particular examples of the above dyes, pigments, and carbon black may include, without limitation, Mitsubishi carbon black M1000, Mitsubishi carbon black MA-100, Mitsubishi carbon black #40, Vitoria pure blue (42595), oramine O (41000), catilon brilliant flavine (basic 13), rhodamine 6GCP (45160), rhodamine B (45170), sakuranin OK 70:100 (50240), erioglaucine X (42080), NO. 120/lionel yellow (21090), lionel yellow GRO (21090), symuler fast yellow GRO (21090), symuler fast yellow 8GF (21105), benzidine yellow 4J-564D (21095), paliotol yellow L0960 (pigment yellow 139), yellow pigment E4-GN (pigment yellow 150 derivative), symuler fast red 4015 (12355), lionel red 7B4401 (15850), fastogen blue JGR-L (74160), lionel blue SM (26150), lionel blue ES (pigment blue 15:6, pigment blue 1536), lionogen red GD (pigment red 168, pigment red 108), chromophthal red A2B (pigment red 177), ilgapore red B-CF (pigment red 254), heliogen green L8730 (pigment green 7), lionel green 2YS (pigment green 36), or the like.

The binder resin plays a role in supporting the pattern and may be a copolymer, including a monomer having a carboxyl group and another monomer having an unsaturated bond.

The monomer having a carboxyl group is an unsaturated carboxylic acid having at least one carboxyl group in the molecule and may include, for example: monocarboxylic acids such as acrylic acid, methacrylic acid, crotonic acid, etc.; dicarboxylic acids such as fumaric acid, metaconic acid, itaconic acid, etc.; and anhydrides thereof, and the like.

Monomers having an unsaturated bond are without limitation so long as they are any monomer having an unsaturated double bond copolymerizable with the monomer having a carboxyl group. Particular examples thereof may include: unsaturated carboxylic acid ester compounds such as methyl(meth)acrylate, ethyl(meth)acrylate, butyl(meth)acrylate, 2-hydroxyethyl(meth)acrylate, etc.; unsubstituted or substituted alkylester compounds of unsaturated carboxylic acids such as aminoethyl(meth)acrylate; unsaturated carboxylic acid ester compounds having alicyclic substituents such as cyclopentyl(meth)acrylate, cyclohexyl(meth)acrylate, methylcyclohexyl(meth)acrylate, cycloheptyl(meth)acrylate, cyclooctyl(meth)acrylate, cyclopentenyl(meth)acrylate, cyclohexenyl(meth)acrylate, cycloheptenyl(meth)acrylate, cyclooctenyl(meth)acrylate, isobornyl(meth)acrylate, adamantyl(meth)acrylate, norbornyl(meth)acrylate, etc.; unsaturated carboxylic acid ester compounds having thermo-curable substituents such as 3-methyl-3-(meth)acryloxymethyloxetane, 3-ethyl-3-(meth)acryloxymethyloxetane, 3-methyl-3-(meth)acryloxyethyloxetane, etc.; unsaturated glycidyl carboxylic acid ester compounds such as glycidyl(meth)acrylate, etc.; unsaturated carboxylic acid ester compounds having aromatic ring-containing substituents such as benzyl(meth)acrylate, phenoxy(meth)acrylate, etc.; aromatic vinyl compounds such as styrene, vinyl toluene, α-methyl styrene, etc.; carboxylic acid vinylesters such as vinyl acetate, vinyl propionate, etc.; cyanated vinyl compounds such as (meth)acrylonitrile, α-chloroacrylonitrile, etc., which can be used alone or in combination with two or more thereof.

Examples of the copolymer may include 3-ethyl-3-methacryloxymethyloxetane/benzyl methacrylate/methacrylic acid copolymer, 3-ethyl-3-methacryloxymethyloxetane/benzyl methacrylate/methacrylic acid/styrene copolymer, 3-ethyl-3-methacryloxymethyloxetane/methyl methacrylate/methacrylic acid copolymer, 3-ethyl-3-methacryloxymethyloxetane/methyl methacrylate/methacrylic acid/styrene copolymer, or the like.

The polymerizable compound is without limitation and may be any compound generally used in the related art, for example, a compound having an epoxy group hardened by heat.

The compound having an epoxy group is without limitation and may include, for example, a curable monomer having an epoxy(meth)acrylate functional group structure.

The curable monomer having an epoxy(meth)acrylate functional group structure may be any one selected from commercially available compounds, for example, a compound having two epoxy acrylate functional groups or four epoxy acrylate functional groups within a molecule.

The polymerization initiator used herein is without limitation and may include any polymerization initiator used in the related art, for example, triazine compounds, acetophenone compounds, xanthone compounds, benzoin compounds, imidazole compounds, etc., which can be used alone or in combination with two or more thereof.

Particular examples of the polymerization initiator may include 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphthyl-6-triazine, benzophenone, p-(diethylamino)benzophenone, 2,2-dichloro-4-phenoxyacetophenone, 2,2-diethoxyacetophenone, 2,2-dibutoxyacetophenone, 2-hydroxy-2-methylpropiophenone, p-t-butyl trichloroacetophenone, 2-methylthioxanthone, 2-isobutylthioxanthone, 2-dodecylthioxanthone, 2,4-dimethylthioxanthone, 2,4-diethylthioxanthone, 2,2′-bis(2-chlorophenyl)-4,4′,5,5′-tetraphenyl-1,2′-biimidazole compounds, etc., which can be used alone or in combination with two or more thereof.

Solvents used herein are without limitation and may include, for example: ethyleneglycol monoalkylethers such as ethyleneglycol monomethylether, ethyleneglycol monoethylether, ethyleneglycol monopropylether, ethyleneglycol monobutylether, etc.; diethyleneglycol dialkylethers such as diethyleneglycol dimethylether, diethyleneglycol diethylether, diethyleneglycol dipropylether, diethyleneglycol dibutylether, etc.; alkyleneglycol alkylether acetates such as propyleneglycol monomethylether acetate, propyleneglycol monoethylether acetate, propyleneglycol monopropylether acetate, etc.; alkyleneglycol alkylethers such as propyleneglycol monomethylether, propyleneglycol monoethylether, propyleneglycol monopropylether, etc.; (alkoxy)alkylesters such as ethyl acetate, ethyl lactate, methyl cellosolve acetate, ethyl cellosolve acetate, methoxybutyl acetate, methoxypentyl acetate, etc.; aromatic hydrocarbons such as benzene, toluene, xylene, etc.; ketones such as methylethylketone, acetone, methylamylketone, methylisobutylketone, cyclohexanone, etc.; alcohols such as ethanol, propanol, butanol, hexanol, cyclohexanol, ethyleneglycol, glycerin, etc., which can be used alone or in combination with two or more thereof.

<Formation of a Non-Conductive Color Pattern by Photolithography>

A non-conductive color pattern 312 formed by photolithography may be provided by applying a composition for forming a non-conductive color pattern to a non-display part on one face of a window plate 311, followed by exposure and development of the same.

The above application is a process of preparing a smooth and flat coating film 312′ by applying a composition for forming a non-conductive color pattern on one face of a window plate 311, and pre-drying the same to remove volatile components, such as solvents.

Methods for the application are without limitation and may include, for example, spray coating, roll coating, coating using a slit nozzle, such as an injection-nozzle type application, rotational application such, as centrally drop-spinning, extrusion coating, bar coating, or the like.

The above exposure is a process of irradiating UV rays to a specific area through a mask in order to provide a desired pattern on the film obtained, as described above. In this regard, parallel light uniformly irradiates throughout an exposure part, and a mask aligner or stepper may be used so that the positions of a mask and substrate completely coincide.

The above development is a process of forming a desired pattern by contacting the coating film obtained after complete hardening, with an alkaline solution as a developer, and then, developing the same. After developing, post-drying may be further executed at 150 to 230° C. for 10 to 60 minutes, as necessary. Optionally, baking may further be included after drying.

When the non-conductive color pattern 312 is formed by photolithography, the non-conductive color pattern 312 may be provided using a composition for forming a non-conductive color pattern, which includes a coloring agent, alkaline soluble resin, polymerizable compound, polymerization initiator, solvent, and the like.

The alkaline soluble resin is without limitation so long as it is reactive to light or heat, functions as a coupler resin in relation to coloring materials, and is soluble in an alkaline developer, and may include, for example, acryl copolymer.

The acryl copolymer is without limitation and may include, for example, a copolymer of a carboxyl group-containing monomer and another monomer having an unsaturated double bond copolymerizable with the former.

The monomer having a carboxyl group may be an unsaturated carboxylic acid having at least one carboxyl group in a molecule, for example, acrylic acid, methacrylic acid, crotonic acid, itaconic acid, maleic acid, fumaric acid, or the like. These may be used alone or in combination with two or more thereof.

The monomer having a polymerizable carbon-carbon unsaturated bond may include, for example: aromatic vinyl compounds such as α-methyl styrene, vinyl toluene, etc.; unsaturated carboxylates such as methyl(meth)acrylate, ethyl(meth)acrylate, butyl(meth)acrylate, 2-hydroxyethyl(meth)acrylate, benzyl(meth)acrylate, etc.; unsaturated aminoalkyl carboxylates such as aminoethyl acrylate, etc.; unsaturated glycidyl carboxylates such as glycidyl(meth)acrylate, etc.; vinyl carboxylates such as vinyl acetate, vinyl propionate, etc.; vinyl cyanide compounds such as (meth)acrylonitrile, α-chloroacrylonitrile, etc., which can be used alone or in combination with two or more thereof.

A polymerizable compound is a compound capable of polymerization via light and reaction with the polymerization initiator described below, without limitation thereof. Preferably, the polymerizable compound may include, for example, mono-functional monomers, di-functional monomers, other poly-functional monomers, or the like, which can be used alone or in combination with two or more thereof.

Mono-functional monomers may include, for example, nonylphenylcarbitol acrylate, 2-hydroxy-3-phenoxypropyl acrylate, 2-ethylhexylcarbitol acrylate, 2-hydroxyethyl acrylate, N-vinylpyrrolidone, or the like, which can be used alone or in combination with two or more thereof.

Di-functional monomers may include, for example, 1,6-hexanediol(meth)acrylate, ethyleneglycol di(meth)acrylate, neopentylglycol di(meth)acrylate, triethyleneglycol di(meth)acrylate, bis(acryloxyethyl)ether of bisphenol A, 3-methylpentanediol di(meth)acrylate, or the like, which can be used alone or in combination with two or more thereof.

Other poly-functional monomers may include, for example, trimethylolpropane tri(meth)acrylate, ethoxylated trimethylolpropane tri(meth)acrylate, propoxylated trimethylolpropane tri(meth)acrylate, pentaerythritol tri(meth)acrylate, pentaerythritol tetra(meth)acrylate, pentaerythritol penta(meth)acrylate, ethoxylated dipentaerythritol hexa(meth)acrylate, propoxylated dipentaerythritol hexa(meth)acrylate, dipentaerythritol hexa(meth)acrylate, or the like, which can be used alone or in combination with two or more thereof.

Other components may have the same constitutional composition as that of a composition for forming a non-conductive color pattern when the non-conductive color pattern 312 is formed by offset printing, as described above.

<Formation of a Non-Conductive Shielding Pattern by Offset Printing>

Similarly, a non-conductive shielding pattern 313 may also be formed by the same process as that used for forming the non-conductive color pattern 312.

The non-conductive shielding pattern 313 formed by offset printing may be provided using a composition for forming a non-conductive shielding pattern, which includes a shielding agent, binder resin, polymerizable compound, polymerization initiator, combined organic pigment, additive, solvent, and the like.

The shielding agent is without limitation so long as it has insulating properties and shielding effects, and may include, for example: black or white colorless pigments; and pigments expressing black or white by mixing the same, which can used alone or in combination with two or more thereof.

The pigments appearing black or white by mixing the same are without limitation and may include, for example, water-soluble azo pigments, insoluble azo pigments, phthalocyanine pigments, quinacridone pigments, isoindolinone pigments, isoindoline pigments, perylene pigments, perinone pigments, dioxazine pigments, anthraquinone pigments, dianthraquinonyl pigments, anthrapyrimidine pigments, anthanthrone pigments, indanthrone pigments, pyranthrone pigments, diketopyrrolopyrrole pigments, etc., which can be used alone or in combination with two or more thereof.

More particularly, C.I. pigment yellow 20, 24, 31, 53, 83, 86, 93, 94, 109, 110, 117, 125, 137, 138, 139, 147, 148, 150, 153, 154, 166, 173, 180, and 185; C.I. pigment orange 13, 31, 36, 38, 40, 42, 43, 51, 55, 59, 61, 64, 65, and 71; C.I. pigment red 9, 97, 105, 122, 123, 144, 149, 166, 168, 176, 177, 180, 192, 215, 216, 224, 242, 254, 255, and 264; C.I. pigment violet 14, 19, 23, 29, 32, 33, 36, 37, and 38; C.I. pigment blue 15 (15:3, 15:4, 15:6, etc.), 21, 28, 60, 64, and 76; C.I. pigment green 7, 10, 15, 25, 36, 47, and 58; C.I. pigment brown No. 28; C.I. pigment black 1 and 7, etc., may be included, which can be used alone or in combination with two or more thereof.

Optionally, the shielding agent may further include carbon black, aniline black, chromium oxide, iron oxide, titanium black, or mixtures thereof.

The other components, except for the shielding agent, may have the same constitutional composition as that of the composition for forming a non-conductive color pattern when the non-conductive color pattern 312 is formed by offset printing.

<Formation of a Non-Conductive Shielding Pattern by Photolithography>

A non-conductive shielding pattern 313 formed by photolithography may be provided using a composition for forming a non-conductive shielding pattern, which includes a shielding agent, alkaline soluble resin, polymerizable compound, polymerization initiator, solvent, and the like.

The shielding agent may be identical to that used in the composition for forming a non-conductive shielding pattern when the non-conductive shielding pattern 313 is formed by offset printing, while the other components may be identical to those included in the composition for forming a non-conductive color pattern when the non-conductive color pattern 312 is formed by photolithography.

A non-conductive shielding pattern 313 formed by photolithography may be provided by applying a composition for forming a non-conductive color pattern to a non-display part on one face of a window plate 311, followed by exposure and development of the same. The above application is a process of preparing a smooth and flat coating film 313′ by applying a composition for forming a non-conductive color pattern on one face of a window plate 311, and pre-drying the same to remove volatile components, such as solvents. The subsequent process for forming a non-conductive shielding pattern 313 may also be same process as that used for forming the non-conductive color pattern 312.

Both of the compositions for forming a non-conductive color pattern and the compositions for forming a non-conductive shielding pattern, which are used to form the non-conductive color pattern 312 and non-conductive shielding pattern 313, respectively, by offset printing or photolithography, may have a viscosity of 1 cps to 30 cps and, preferably, 2 cps to 10 cps. If the viscosity is within the above range of 1 cps to 30 cps, ink stability (a process maintaining the ability of the ink) is maintained while appropriately performing ink coating, thereby enabling uniform coating and printing.

An overall thickness of the non-conductive color pattern 312 and the non-conductive shielding pattern 313 may range from 1 to 10 μm and, preferably, 1 to 5 μm. When an overall thickness of the above non-conductive pattern is within the above range of 1 to 10 μm, hiding and shielding effects are attained (viz., hiding an inner board and wiring of a device), the reliability of a conductive electrode pattern layer may be improved, and a thin touch screen panel may be produced.

A thickness ratio between the non-conductive color pattern and the non-conductive shielding pattern may range from 1:0.1 to 0.5, preferably, 1:0.1 to 0.3. When the thickness ratio between the non-conductive color pattern 312 and the non-conductive shielding pattern 313 is within the above range of 1:0.1 to 0.5, the inner board and wiring of the device may be hidden and shielded while expressing various colors.

A light transmittance of the non-conductive shielding pattern 313 may be 0.1 to 5%, preferably, 0.1 to 3% of light transmittance of the non-conductive color pattern 312. When the light transmittance of the non-conductive shielding pattern 313 is within the above range of 0.1 to 5%, shielding effects to hide the inner board and wiring may be maximized.

The method for preparing a touch screen panel of the present invention may further include conventional processes used in the related art after formation of the non-conductive pattern 320 described above. For instance, the above method may further include: forming a conductive electrode pattern layer 314 on the window plate 311 having the non-conductive pattern 320 formed thereon; forming an electrode pattern 315 on an area corresponding to a non-display part in the conductive electrode pattern layer 314; forming a scattering-preventative film 316 on the window plate 311 having the conductive (transparent) electrode pattern layer 314 and the electrode pattern 315 formed thereon; and connecting the electrode pattern 315 to a terminal 317 of a printed circuit board.

After formation of the non-conductive pattern, a conductive electrode pattern layer 314 is formed on the window plate 311 having the non-conductive pattern 320 formed thereon.

The conductive electrode pattern layer 314 may be formed using the materials described above, and a method for forming the same is without limitation. For instance, the above conductive electrode pattern layer may be formed by photolithography, using an etching paste, inkjet printing, screen printing, pad printing, gravure printing, flexography printing, offset printing, stencil printing, imprinting, or the like.

Subsequently, an electrode pattern 315 may be formed on an area corresponding to the non-display part in the conductive electrode pattern layer 314.

The electrode pattern 315 may also be formed by the same process as that used for forming the conductive electrode pattern layer 314.

Thereafter, a scattering-preventative film 316 may be formed on the window plate 311 having the conductive (transparent) electrode pattern layer 314 and the electrode pattern 315 formed by the above processes.

The scattering-preventative film 316 may be formed using the materials described above, and a method for forming the same is without limitation and may include, for example, spin coating, roll coating, spray coating, dip coating, flow coating, doctor blade and dispensing, inkjet printing, screen printing, pad printing, gravure printing, offset printing, flexography printing, stencil printing, imprinting, and the like.

Subsequently, a terminal 317 of a printed circuit board is connected to the electrode pattern 315.

The touch screen panel according to the present invention, prepared by the above processes, may include a non-conductive pattern having desired colors and shielding functions thereon, wherein the non-conductive pattern has decreased thickness to enable the preparation of a thin touch screen panel, prevent ink leakage through the holes of a window plate, and improve the reliability of a conductive electrode pattern layer, thereby reducing failure rates.

What is claimed is:

1. A touch screen panel, comprising:
a window plate;
a non-conductive color pattern formed on a non-display part on one face of the window plate; and
a non-conductive shielding pattern formed on the non-conductive color pattern.

2. The touch screen panel according to claim 1, wherein the window plate is formed of at least one selected from the group consisting of glass, polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), cellulose acetate propionate (CAP), and a combination thereof.

3. The touch screen panel according to claim 1, wherein an overall thickness of the non-conductive color pattern and non-conductive shielding pattern ranges from 1 to 10 μm.

4. The touch screen panel according to claim 1, wherein a thickness ratio between the non-conductive color pattern and the non-conductive shielding pattern ranges from 1:0.1 to 0.5.

5. The touch screen panel according to claim 1, wherein a light transmittance of the non-conductive shielding pattern ranges from 0.1 to 5% of light-transmittance of the non-conductive color pattern.

6. The touch screen panel according to claim 1, wherein the non-conductive color pattern and non-conductive shielding pattern are formed by offset printing or photolithography, independently of each other.

7. A method for preparing a touch screen panel, comprising:
forming a non-conductive color pattern on a non-display part on one face of a window plate by offset printing or photolithography; and
forming a non-conductive shielding pattern on the non-conductive color pattern by offset printing or photolithography.

8. The method according to claim 7, wherein the non-conductive color pattern formed by offset printing is provided using a composition for forming a non-conductive color pattern, which includes a coloring agent, binder resin, polymerizable compound, polymerization initiator, and solvent.

9. The method according to claim 7, wherein the non-conductive color pattern formed by photolithography is provided using a compositing for forming a non-conductive color pattern, which includes a coloring agent, alkaline soluble resin, polymerizable compound, polymerization initiator, and solvent.

10. The method according to claim 7, wherein the non-conductive shielding pattern formed by offset printing is provided using a composition for forming a non-conductive shielding pattern, which includes a shielding agent, binder resin, polymerizable compound, polymerization initiator, and solvent.

11. The method according to claim 7, wherein the non-conductive shielding pattern formed by photolithography is provided using a composition for forming a non-conductive shielding pattern, which includes a shielding agent, alkaline soluble resin, polymerizable compound, polymerization initiator, and solvent.

12. The method according to claim 8, wherein the composition for forming a non-conductive color pattern and the composition for forming a non-conductive shielding pattern have a viscosity of 1 to 30 cps, respectively.

13. The method according to claim 7, further comprising:
forming a conductive electrode pattern layer on the window plate having the non-conductive pattern formed thereon;
forming an electrode pattern on an area corresponding to the non-display part in the conductive electrode pattern layer;
forming a scattering-preventative film on the window plate having the conductive transparent electrode pattern layer and the electrode pattern formed thereon; and
connecting the electrode pattern to a terminal of a printed circuit board.

14. The method according to claim 13, wherein the conductive electrode pattern layer and the electrode pattern are independently formed of at least one selected from the group consisting of indium-tin oxide (ITO), indium-zinc oxide (IZO), zinc oxide (ZnO), indium-zinc-tin oxide (IZTO), cadmium-tin oxide (CTO), poly(3,4-ethylenedioxythiophene)(PEDOT), carbon nanotube (CNT), and metal wire.
